(19) United States
(12) Patent Application Publication
(10) Pub. No.: US 2026/0259448 A1
(43) Pub. Date: Sep. 3, 2026

(54) DISPLAY MODULE AND DISPLAY DEVICE

(71) Applicants: Wuhan BOE Optoelectronics Technology Co., Ltd., Wuhan, Hubei (CN); BOE Technology Group Co., Ltd., Beijing (CN)

(72) Inventors: Chuang CHEN, Beijing (CN); Xia SHI, Beijing (CN); Wei ZHANG, Beijing (CN); Jie HAN, Beijing (CN); Narui ZHANG, Beijing (CN); Xing LI, Beijing (CN); Dongxu YUAN, Beijing (CN); Dalong MAO, Beijing (CN); Zihao WANG, Beijing (CN); Zhiheng MO, Beijing (CN); Qin ZHANG, Beijing (CN); Zhong WAN, Beijing (CN); Geng LI, Beijing (CN)

(21) Appl. No.: 18/995,787

(22) PCT Filed: Apr. 22, 2024
(86) PCT No.: PCT/CN2024/089193

§ 371 Date: Jan. 16, 2025

(30) Foreign Application Priority Data
May 30, 2023 (CN) 202310626677.5

(51) Int. Cl. G02F 1/1335; G02F 1/1339

(52) U.S. Cl. CPC G02F 1/133509; G02F 1/133528; G02F 1/1339

(57) ABSTRACT

A display module and a display device. The display module includes: a backlight module; a liquid crystal display panel located on the side of a light exit surface of the backlight module, the liquid crystal display panel being divided into a display area and a non-display area located on the periphery of the display area, and the liquid crystal display panel including a first substrate, a second substrate, and a liquid crystal layer located between the first substrate and the second substrate; and a light adjusting structure, the light adjusting structure being located in the non-display area, and the light adjusting structure being used for shielding light, which is irradiated to the edge of the display area of the liquid crystal display panel, in the backlight module. The liquid crystal display panel, the light adjusting structure is provided at the non-display area.

### CROSS-REFERENCE TO RELATED APPLICATIONS

This application is a National Stage of International Application No. PCT/CN2024/089193, filed on Apr. 22, 2024, which claims priority to Chinese Patent Application No. 202310626677.5, filed on May 30, 2023, in the China National Intellectual Property Administration, with a name “Display module, and display device”. The entire disclosure of the above applications is incorporated herein by reference.

### TECHNICAL FIELD

The present disclosure relates to the field of display technology, and in particular to a display module and a display device.

### BACKGROUND

With the advancement of science and technology and the continuous improvement of human living standards, current liquid crystal display devices are developing towards borderless and full-screen, and the market's performance requirements for liquid crystal display devices are increasing, such as the demand for liquid crystal display devices of different sizes.

### SUMMARY

In the first aspect, some embodiments of the present disclosure provide a display module, including:
a backlight module; a liquid crystal display panel located on a light-emitting side of the backlight module, wherein the liquid crystal display panel is divided into a display area and a non-display area located around the display area, and the liquid crystal display panel includes a first substrate, a second substrate, and a liquid crystal layer located between the first substrate and the second substrate; a light adjustment structure located in the non-display area and configured to shield light from the backlight module that is irradiated toward an edge of the display area of the liquid crystal display panel.

The embodiments of the disclosure provide a display module includes a backlight module and a liquid crystal display panel, the liquid crystal display panel is located on the light output side of the backlight module, the liquid crystal display panel includes a first substrate, a second substrate and a liquid crystal layer, the liquid crystal layer is positioned between the first substrate and the second substrate, the first substrate and the second substrate are used together to control the deflection of liquid crystal molecules in the liquid crystal layer to control the light source of the backlight module to pass through, in order to improve the problem of light leakage in all directions of the liquid crystal display panel, a light adjustment structure is arranged at the non-display area in order to prevent light leakage at the junction of the non-display area and the display area, the shading effect can be realized, the light leakage of the liquid crystal display panel is improved, the display effect and image quality are guaranteed, and the cost of the light adjustment structure is almost not increased, and the process is not increased at the same time, and the production capacity is not affected.

In some embodiments, the display module further includes a height side and a bottom side arranged opposite to each other; the light adjustment structure is close to the height side.

In some embodiments, the liquid crystal display panel further includes a first polarizer and a second polarizer; the first polarizer is arranged on a side of the first substrate facing away from the second substrate, and the second polarizer is arranged on a side of the second substrate facing away from the first substrate, and an orthographic projection of the first polarizer on the liquid crystal layer covers the liquid crystal layer in a thickness direction of the liquid crystal display panel, and an orthographic projection of the second polarizer on the liquid crystal layer covers the liquid crystal layer in the thickness direction of the liquid crystal display panel;
the liquid crystal display panel further includes a frame sealant; the frame sealant is located between the first substrate and the second substrate, an orthographic projection of the frame sealant on the first substrate is in a ring shape, and the frame sealant surrounds the liquid crystal layer.

In some embodiments, the light adjustment structure includes a first polarizing portion and a second polarizing portion;
the first polarizing portion and the first polarizer are disposed in a same layer, and the second polarizing portion and the second polarizer are disposed in a same layer; an orthographic projection of the first polarizing portion on the liquid crystal layer does not overlap with the liquid crystal layer in the thickness direction of the liquid crystal display panel, and an orthographic projection of the second polarizing portion on the liquid crystal layer does not overlap with the liquid crystal layer in the thickness direction of the liquid crystal display panel.

In some embodiments, in the thickness direction of the liquid crystal display panel, an orthographic projection of the first polarizing portion on the second polarizing portion coincides with a surface of the second polarizing portion facing the first polarizing portion.

In some embodiments, the first polarizing portion and the first polarizer are an integrated structure; the second polarizing portion and the second polarizer are an integrated structure.

In some embodiments, the light adjustment structure includes a light shielding portion;
the light shielding portion is located between the first substrate and the second substrate, and an orthographic projection of the light shielding portion on the first substrate is located in the non-display area in the thickness direction of the liquid crystal display panel.

In some embodiments, the light shielding portion includes black sealant; and a width of the light shielding portion ranges from 5.5 mm to 7.5 mm in a direction from the bottom side to the height side.

In some embodiments, the light adjustment structure includes a light blocking portion, the light blocking portion is located on a side of the second substrate facing the second polarizer, and an orthographic projection of the light blocking portion on the second substrate is located in the non-display area.

In some embodiments, the light blocking portion includes a light shielding tape; and a width of the light shielding tape ranges from 3 mm to 4 mm in a direction from the bottom side to the height side.

In some embodiments, the light adjustment structure includes the frame sealant filled with dyes of at least two colors.

In some embodiments, the light adjustment structure includes dummy pixels, and the dummy pixels are located in a dummy pixel region between the display area and the non-display area;
the dummy pixels are configured to display a black screen and to shield light at the edge of the display area.

In some embodiments, a width of the dummy pixels ranges from 1.5 mm to 2.5 mm in a direction from the bottom side to the height side.

In some embodiments, the orthographic projection of the frame sealant on the first substrate is completely located within a range of an orthographic projection of the dummy pixels on the first substrate.

In some embodiments, a distance between a side of the dummy pixels close to the height side and the height side ranges from 0.1 mm to 3.5 mm.

In some embodiments, a distance between a side of the light adjustment structure close to the height side and the height side ranges from 0.1 mm to 3.2 mm.

In some embodiments, the liquid crystal display panel further includes a spacer, and the spacer is arranged between the first substrate and the second substrate;
an orthographic projection of the spacer on the first substrate does not overlap with the orthographic projection of the frame sealant on the first substrate.

In some embodiments, a distance between a side of the spacer close to the height side and the height side ranges from 5.7 mm to 8.3 mm.

In some embodiments, the frame sealant is configured to cover a first through hole located at a corner of the second substrate; a diameter of a corner of the frame sealant ranges from 0.4 mm to 0.6 mm.

In the second aspect, some embodiments of the present disclosure provide a display device, including the display module according to any of description in the first aspect.

### BRIEF DESCRIPTION OF FIGURES

In order to more clearly illustrate the technical solutions in the embodiments of the present disclosure, the drawings required for use in the description of the embodiments will be briefly introduced below. Obviously, the drawings described below are only some embodiments of the present disclosure. For a person skilled in the art, other drawings can be obtained based on these drawings without paying creative work.

FIG. 1 is a schematic diagram of an external structure of a display module provided by an embodiment of the present disclosure;

FIG. 2 is a perspective view of a display module provided by an embodiment of the present disclosure;

FIG. 3 is the first schematic diagram of a light adjustment structure as a polarizing portion provided by an embodiment of the present disclosure;

FIG. 4 is the second schematic diagram of a light adjustment structure as a polarizing portion provided by an embodiment of the present disclosure;

FIG. 5 is a schematic diagram of a light adjustment structure as a light shielding portion provided by an embodiment of the present disclosure;

FIG. 6 is a schematic diagram of a light adjustment structure as a light blocking portion provided by an embodiment of the present disclosure;

FIG. 7 is the first enlarged schematic diagram of a local portion corresponding to the X in FIG. 1;

FIG. 8 is the second enlarged schematic diagram of a local portion corresponding to the X in FIG. 1;

FIG. 9 is an enlarged schematic diagram of a local portion of the frame sealant at the Y corresponding to FIG. 5;

FIG. 10 is an enlarged schematic diagram of a local portion corresponding to the Y in FIG. 5;

FIG. 11 is a schematic diagram of positions of the light shielding portion and the second through hole provided by an embodiment of the present disclosure.

### DETAILED DESCRIPTION

In order to make the purpose, technical solutions and advantages of the present disclosure clearer, the present disclosure will be further described in detail below in conjunction with the accompanying drawings. Obviously, the described embodiments are only part of the embodiments of the present disclosure, rather than all of the embodiments. Based on the embodiments in the present disclosure, all other embodiments obtained by a person skilled in the art in the field without creative work are within the scope of protection of the present disclosure.

At present, the size of the mask in the industry is relatively fixed. In order to save the high mask cost, the existing fixed mask exposure is generally used to form a non-standard LCD panel 1. If it is a line screen, the cold cutting process technology is used to cut the 16:9 product into a 32:9 line screen of the same ratio. The size of the non-standard LCD panel is smaller than the maximum exposure area of the mask. After the LCD panel is formed by the existing fixed mask exposure, the mask shielding exposure method is required. However, the cold cutting process has an impact on the image quality and reliability of the product that cannot be ignored. To be specific, the shielding exposure method will cause light leakage in all directions of the LCD panel.

In order to improve the image quality and reliability of the line screen products and avoid the high cost caused by redesigning and producing the mask, the shielding exposure technology is adopted. The so-called shielding exposure technology means: for example, in order to save the cost of re-producing masks of different sizes, the existing size of the mask is used, and the mask of the existing size is matched with the baffle, and a part of the mask is shielded to form a non-standard liquid crystal display panel 1.

In the process of preparing the color film substrate of the liquid crystal display panel 1, a baffle is used in conjunction with a mask of existing size. The limitation of the moving position of the baffle limits the exposure accuracy, resulting in abnormal exposure position of the black matrix, that is, causing light leakage in all directions of the liquid crystal display panel 1.

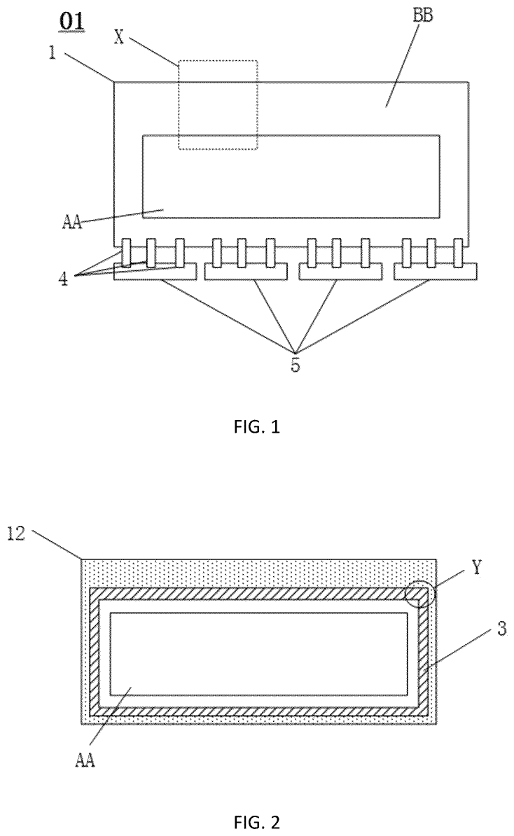

As shown in FIG. 1 and FIG. 2, in the first aspect, a display module 01 provided by an embodiment of the present disclosure includes:
a backlight module;
a liquid crystal display panel 1 located on the light-emitting side of the backlight module, the liquid crystal display panel 1 is divided into a display area AA and a non-display area BB located around the display area AA, and the liquid crystal display panel 1 includes a first substrate 11, a second substrate 12, and a liquid crystal layer 15 located between the first substrate 11 and the second substrate 12;
a light adjustment structure 2 located in the non-display area BB and configured to shield the light irradiated toward the edges of the display area AA of the liquid crystal display panel 1 from the backlight module.

It should be noted that the display module 01 provided in the embodiment of the present disclosure includes a backlight module and a liquid crystal display panel 1. The liquid crystal display panel 1 is located on the light-emitting side of the backlight module. The liquid crystal display panel 1 includes a first substrate 11, a second substrate 12 and a liquid crystal layer 15. The liquid crystal layer 15 is located between the first substrate 11 and the second substrate 12. The first substrate 11 and the second substrate 12 cooperate to control the deflection of liquid crystal molecules in the liquid crystal layer 15 to control the passage of the light source of the backlight module. In order to improve the problem of light leakage in all directions of the liquid crystal display panel 1, a light adjustment structure 2 is disposed in the non-display area BB to prevent light leakage at the junction of the non-display area BB and the display area AA, thereby achieving a shading effect, improving the light leakage of the liquid crystal display panel 1, and ensuring the display effect and picture quality. The use of the light adjustment structure 2 has almost no increase in cost, and at the same time does not increase the process and does not affect the production capacity.

For example, the first substrate 11 is a color filter substrate, the second substrate 12 is an array substrate, and the liquid crystal display panel 1 includes an array substrate and a color filter substrate, and a liquid crystal layer 15 located between the array substrate and the color filter substrate. Since the liquid crystal layer 15 itself does not emit light, the light source is provided by the backlight module. A thin film transistor (TFT) is provided in the array substrate to control the deflection of the liquid crystal molecules to control the light source of the backlight module to pass through. The color filter layer in the color filter substrate realizes the colorization of the light source.

As shown in FIG. 1, the display module 01 provided in the embodiment of the present disclosure has a height side and a bottom side arranged opposite to each other. The bottom side refers to a side connected to the driving chip 5, and the height side refers to a side opposite to the bottom side. For example, the driving chip 5 (IC) can also adopt the COF (Chip on Flex or Chip On Film) encapsulation technology, that is, a flexible printed circuit 4 (FPC) is arranged to be connected to the liquid crystal display panel 1, and the driving chip 5 (IC) is arranged on the flexible printed circuit 4, that is, the driving chip 5 (IC) is connected to the subpixels of the liquid crystal display panel 1 through the flexible printed circuit 4.

At present, the development of liquid crystal display devices is towards borderless and full screen. In order to prevent light leakage around the liquid crystal display panel 1, a black matrix is generally coated around the liquid crystal display panel 1. In the process of using a mask of existing size, matching the mask of existing size with a baffle, and shielding portion of the mask to form a non-standard liquid crystal display panel 1, the first substrate 11 or the second substrate 12 with a width of about 7.5 mm on the height side is not covered by the black matrix due to the limitation of the moving position of the baffle. After the liquid crystal display panel 1 without black matrix coverage is matched with the backlight module, light leakage will occur on the height side.

In order to solve the problem of light leakage on the height side, the light adjustment structure 2 is arranged on the side close to the height side.

As shown in FIG. 2, the liquid crystal display panel 1 further includes a first polarizer 13 and a second polarizer 14. The first polarizer 13 is arranged on a side of the first substrate 11 facing away from the second substrate 12, and the second polarizer 14 is arranged on a side of the second substrate 12 facing away from the first substrate 11. In the thickness direction of the liquid crystal display panel 1, the orthographic projection of the first polarizer 13 on the liquid crystal layer 15 covers the liquid crystal layer 15, and the orthographic projection of the second polarizer 14 on the liquid crystal layer 15 covers the liquid crystal layer 15.

The liquid crystal display panel 1 further includes: a frame sealant 3. The frame sealant 3 is located between the first substrate 11 and the second substrate 1. The orthographic projection of the frame sealant 3 on the first substrate 11 is in a ring shape, and the frame sealant 3 surrounds the liquid crystal layer 15.

The liquid crystal display panel 1 further includes a first polarizer 13 on the side of the first substrate 11 facing away from the second substrate 12, that is, the first polarizer 13 is arranged at the top of the color filter substrate. The liquid crystal display panel 1 further includes a second polarizer 14 on the side of the second substrate 12 facing away from the first substrate 11, that is, the second polarizer 14 is arranged at the bottom of the array substrate. Specifically, referring to FIG. 2, the peripheral area of the liquid crystal display module 01 can be sealed by disposing the frame sealant 3 to seal the array substrate and the color filter substrate, that is, the frame sealant 3 surrounds the liquid crystal layer 15.

There are two polarizers in the liquid crystal display panel 1, which are respectively attached to the first substrate 11 and the second substrate 12. The second polarizer 14 is used to convert the light beam generated by the backlight module into polarized light, and the first polarizer 13 is used to resolve the polarized light after being electrically modulated by the liquid crystal to generate light and dark contrast, thereby generating a display image. The imaging of the liquid crystal display panel 1 must rely on polarized light. Without any polarizer, the liquid crystal display module 01 cannot display an image.

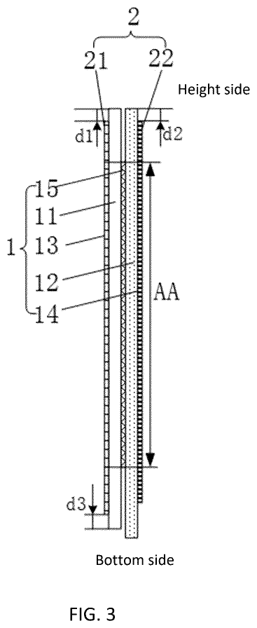

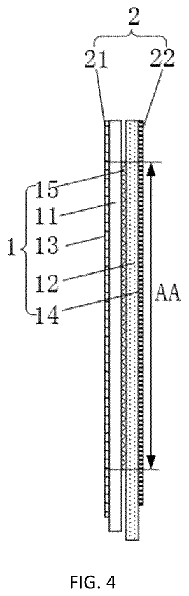

In some specific embodiments, as shown in FIG. 3 and FIG. 4, in order to improve the light leakage problem on the height side, the light adjustment structure 2 includes a first polarizing portion 21 and a second polarizing portion 22.

The first polarizing portion 21 and the first polarizer 13 are arranged at the same layer, and the second polarizing portion 22 and the second polarizer 14 are at the same layer. In the thickness direction of the liquid crystal display panel 1, the orthographic projection of the first polarizing portion 21 on the liquid crystal layer 15 does not overlap with the orthographic project of the first polarizer 13, and the orthographic projection of the second polarizing portion 22 on the liquid crystal layer 15 does not overlap with the orthographic projection of the second polarizer 14. The position of the frame sealant 3 is adjusted, to make the frame sealant 3 on the height side be retracted to the inner edge of the display area AA, and the liquid crystal layer 15 from the height side of the first substrate 11 to the height side of the frame sealant 3 is removed. The first polarizing portion 21 and the second polarizing portion 22 are configured to achieve light shielding. The polarization directions of the first polarizing portion 21 and the second polarizing portion 22 are perpendicular, which is equivalent to a black screen without liquid crystal. That is, the first polarizing portion 21 and the second polarizing portion 22 after removing the liquid crystal play the role of a black matrix, thereby achieving light shielding on the height side.

In the thickness direction of the liquid crystal display panel 1, the orthographic projection of the first polarizing portion 21 on the second polarizing portion 22 coincides with the surface of the second polarizing portion 22 facing the first polarizing portion 21. The first polarizing portion 21 and the second polarizing portion 22 have the same area to ensure the shading effect at the first polarizing portion 21 and the second polarizing portion 22.

For example, the first polarizing portion 21 and the first polarizer 13 are an integrated structure. That is to say, the first polarizing portion 21 and the first polarizer 13 are a whole. The first polarizer 13 is attached to the first substrate 11 as a whole, and the first polarizing portion 21 is a part of the first polarizer 13. Similarly, the second polarizing portion 22 and the second polarizer 14 are a whole, the second polarizer 14 is attached to the second substrate 12, and the second polarizing portion 22 is a part of the second polarizer 14.

Continuing to refer to FIG. 3, the first polarizer 13 and the second polarizer 14 are respectively attached to the first substrate 11 and the second substrate 12, and the part of the first polarizer 13 on the height side in the non-display area BB serves as the first polarizing portion 21, and the portion of the second polarizer 14 on the height side in the non-display area BB serves as the second polarizing portion 22. On the height side, the top side of the first polarizing portion 21 is at a distance d1 from the top side of the first substrate 11, and the top side of the second polarizing portion 22 is at a distance d2 from the top side of the second substrate 12, and the distances d1 and d2 are the same. Considering the fitting accuracy of the first polarizer 13 and the second polarizer 14, d1=d2=0.6 mm. In order to ensure that when the first polarizer 13 and the second polarizer 14 are attached on the first substrate 11 and the second substrate 12, the first polarizer 13 and the second polarizer 14 do not exceed the edges of the first substrate 11 and the second substrate 12, a blank space of d1=d2=0.6 mm is reserved in the design. On the bottom side, the distance d3 between the bottom side of the first polarizer 13 and the bottom side of the first substrate 11 is 1.2 mm, and 1.2 mm is reserved for convenient dispensing of silver glue.

Continuing to refer to FIG. 4, the top side of the first polarizing portion 21 is flush with the top side of the first substrate 11, and the top side of the second polarizing portion 22 is flush with the top side of the second substrate 12. The specific preparation process is: first, the first polarizer 13 and the second polarizer 14 are respectively attached to the first substrate 11 and the second substrate 12; on the height side, the first polarizer 13 and the second polarizer 14 extend beyond the first substrate 11 and the second substrate 12 by a certain distance, and the redundant parts of the first polarizer 13 and the second polarizer 14 are cut off by laser, so that the first polarizing portion 21 of the first polarizer 13 and the second polarizing portion 22 of the second polarizer 14 completely cover the height side, and the polarization directions of the first polarizing portion 21 and the second polarizing portion 22 are perpendicular, which is equivalent to a black screen in the absence of liquid crystal, that is, the first polarizing portion 21 and the second polarizing portion 22 after removing the liquid crystal play the role of a black matrix, thereby achieving light shielding on the height side.

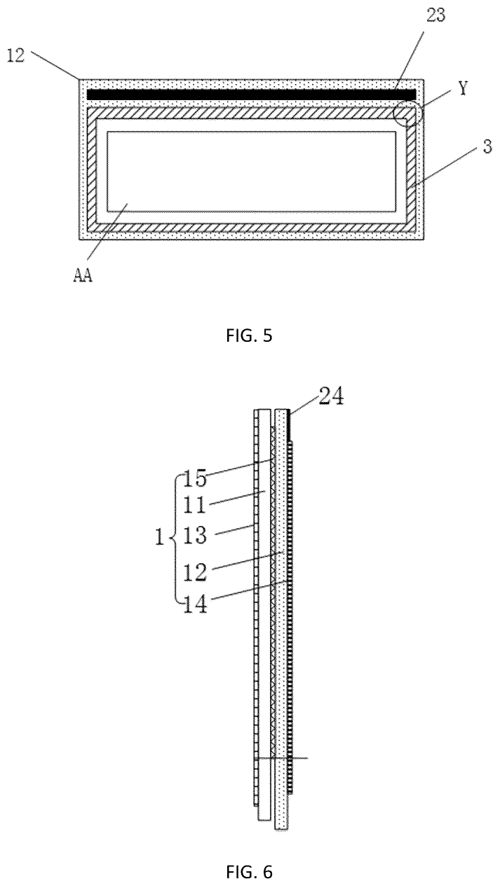

In some specific embodiments, as shown in FIG. 5, the light adjustment structure 2 includes a light shielding portion 23.

The light shielding portion 23 is located between the first substrate 11 and the second substrate 12. In the thickness direction of the liquid crystal display panel 1, the orthographic projection of the light shielding portion 23 on the first substrate 11 is located in the non-display area BB. The light shielding portion 23 includes a black sealant. The width of the light shielding portion 23 from the bottom side to the height side ranges from 5.5 mm to 7.5 mm. For example, the width of the light shielding portion 23 can be 5.5 mm, 6 mm, 6.5 mm, 7 mm or 7.5 mm.

In some specific embodiments, as shown in FIG. 6, the light adjustment structure 2 includes a light blocking portion 24. The light blocking portion 24 is located on a side of the second substrate 12 facing the second polarizer 14, and the orthographic projection of the light blocking portion 24 on the second substrate 12 is located in the non-display area BB. For example, the light blocking portion 24 includes a light shielding tape, that is, the light shielding tape is a black tape, or the light shielding portion 24 is blackened on the side of the second substrate 12 facing away from the first substrate 11, pointing from the bottom side to the height side, and the width of the light shielding tape is 3 mm to 4 mm, for example, the width of the light shielding tape can be 3 mm, 3.2 mm, 3.4 mm, 3.6 mm, 3.8 mm or 4 mm.

In some specific embodiments, the light adjustment structure 2 includes a frame sealant 3 filled with at least two colors of dyes. For example, red dye and blue dye are added to the frame sealant 3. The red dye absorbs green light and blue light, and the blue dye absorbs green light and red light, so that the red light, green light and blue light are completely absorbed, so that the front viewing angle is displayed in black, thereby achieving a shading effect. For example, red dye and green dye are added to the frame sealant 3, the red dye absorbs green light and blue light, and the green dye absorbs blue light and red light, so that the red light, green light and blue light are completely absorbed, so that the front viewing angle is displayed in black, thereby achieving a shading effect. For example, blue dye and green dye are added to the frame sealant 3, the blue dye absorbs green light and red light, and the green dye absorbs blue light and red light, so that the red light, green light and blue light are completely absorbed, so that the front viewing angle is displayed in black, thereby achieving a shading effect. Therefore, any two dye combinations of red dye, green dye and blue dye can absorb red light, blue light and green light, thereby avoiding light leakage. Of course, red dye, green dye and blue dye can also be added to the frame sealant 3. Regarding the dye ratio, for example, the red dye is 10% to 50%, the green dye is 10% to 50%, and the blue dye is 10% to 50%. Of course, the total dye ratio does not exceed 100%.

In the process of preparing the color filter substrate of the liquid crystal display panel 1, a baffle is used in conjunction with a mask of an existing size. The limitation of the movable position of the baffle limits the exposure accuracy, resulting in abnormal exposure positions of the pixel units, that is, light leakage in all directions of the liquid crystal display panel 1. In order to improve the above undesirable phenomenon, the actual exposure position of the pixel unit needs to be controlled within a specific range.

In some specific embodiments, the light adjustment structure 2 includes a dummy pixel 25, and the dummy pixel 25 is located in a dummy pixel region CC between the display area AA and the non-display area BB. The dummy pixel 25 is used to display a black screen and to block the light at the edges of the display area AA. From the bottom side to the height side, the width of the dummy pixel 25 is 1.5 mm to 2.5 mm, for example, the width of the dummy pixel 25 is 1.5 mm, 2 mm or 2.5 mm.

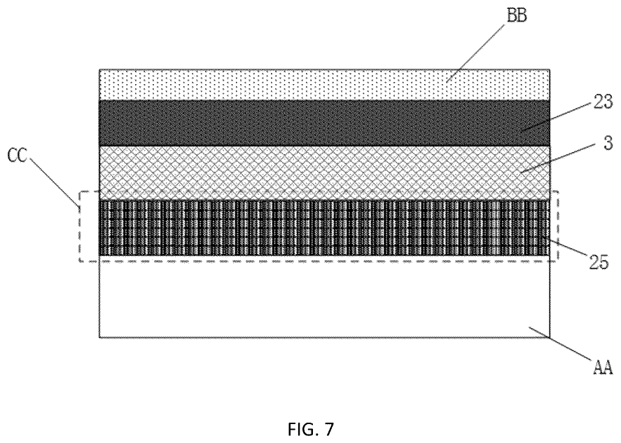

As shown in FIG. 7, multiple rows of dummy pixels 25 are formed by exposure in the dummy pixel region CC between the display area AA and the non-display area BB, and multiple rows of scanning signals corresponding to the dummy pixels 25 are added in the dummy pixel region CC. When the liquid crystal display panel 1 is turned on, LO is continuously displayed, that is, when the display driving circuit receives the LO display grayscale, it controls the liquid crystal display panel 1 to display a black screen. At this time, the display panel display screen seen by users is the same as the shutdown state of the display panel. The dummy pixels 25 are used as a black matrix to block light and prevent light leakage on the height side.

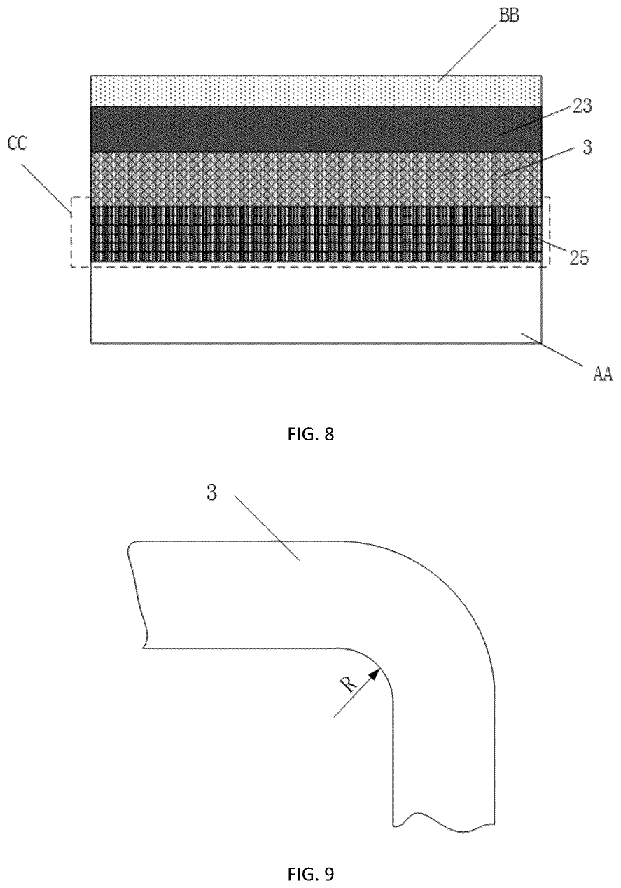

As shown in FIG. 8, when the exposure position of the dummy pixels 25 in the dummy pixel region CC is at the boundary of the frame sealant 3, the width of the frame sealant 3 and the fluctuation of exposure accuracy of the dummy pixels 25 may cause some problems, that is, the frame sealant 3 and the dummy pixels 25 partially overlap, and the frame sealant 3 and the dummy pixel 25 do not overlap partially, which leads to a difference in the box thickness between the frame sealant 3 and the dummy pixels 25, which is not conducive to management and control. Due to the inconsistent box thickness, display problems will occur, that is, the displayed area will be yellow if the box thickness is too high, and the display area will be black if the box thickness is too low. Therefore, the range of the dummy pixels 25 is moved upward toward the height side, and the orthographic projection of the frame sealant 3 on the first substrate 11 is completely located within the orthographic projection range of the dummy pixels 25 on the first substrate 11, ensuring that the dummy pixels 25 and the frame sealant 3 fully overlap, and at the same time, the diameter of the silicon ball of the frame sealant 3 is reduced to ensure that the box thickness remains unchanged. The distance between the side of the dummy pixels 25 close to the height side and the height side ranges from 0.1 mm to 3.5 mm. For example, the distance between the side of the dummy pixels 25 close to the height side and the height side can be 0.1 mm, 0.2 mm, 1 mm, 2 mm, 3 mm, 3.485 mm or 3.5 mm.

Since there are gate metal lines on the second substrate 12, i.e., the array substrate, in order to block the gate metal lines and the light leakage from the height side, the light adjustment structure 2 disposed in the non-display area BB needs to meet the following conditions: the distance between the side of the light adjustment structure 2 close to the height side and the height side is in the range of 0.1 mm to 3.2 mm. The alignment of the light adjustment structure 2 with the height side of the first substrate 11 may cause greening, so the minimum distance between the side of the light adjustment structure 2 close to the height side and the height side is 0.1 mm. Because the gate metal lines reflect light, in order to ensure that the light adjustment structure 2 can block the gate metal lines, the maximum distance between the side of the light adjustment structure 2 close to the height side and the height side is 3.2 mm.

In the process of preparing the color filter substrate of the liquid crystal display panel 1, a baffle is used in conjunction with a mask of an existing size. The limitation of the movable position of the baffle limits the exposure accuracy, resulting in an abnormal exposure position of the spacer, that is, causing light leakage in all directions of the liquid crystal display panel 1. In order to improve the above undesirable phenomenon, the actual exposure position of the spacer needs to be controlled within a specific range.

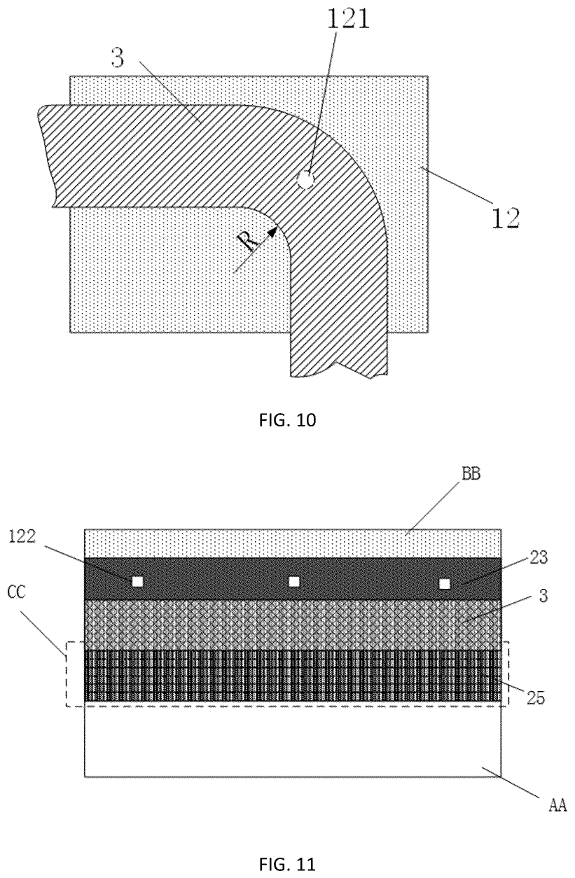

As shown in FIG. 9 and FIG. 10, in some specific embodiments, the liquid crystal display panel 1 further includes a spacer, and the spacer is disposed between the first substrate 11 and the second substrate 12.

The orthographic projection of the spacer on the first substrate 11 does not overlap with the orthographic projection of the frame sealant 3 on the first substrate 11.

The position of the spacer is related to the display effect. When the distance between the spacer and the edge of the first substrate 11 on the height side is less than 8.3 mm, the display area AA is not obviously blackened, so the minimum distance between the spacer and the edge of the first substrate 11 on the height side is 8.3 mm. The spacer and the frame sealant 3 overlapping may yellow the display area. The maximum distance between the inner edge of the frame sealant 3 and the edge of the first substrate 11 on the height side is 5.7 mm, so the minimum distance between the spacer and the edge of the first substrate 11 is 5.7 mm. The distance between the side of the spacer close to the height side and the height side ranges from 5.7 mm to 8.3 mm.

The coating radius of the frame sealant 3 at the corner of the height side is too large. After the fluctuation in the coating process of the frame sealant 3, some through holes on the second substrate 12 cannot be completely covered, that is, the through holes are exposed, and there is a risk of through hole corrosion. In order to ensure that the frame sealant 3 completely covers the first through hole 121, the diameter range of the corner of the frame sealant 3 is 0.4 mm to 0.6 mm. For example, the radius of the corner of the frame sealant 3 is modified to 0.5 mm, and the center of the corner is based on the center line. The distance between the first through hole 121 and the outer edge of the frame sealant 3 is 0.438 mm. After the width of the frame sealant 3 fluctuates, there is still a blank edge of 0.223 mm between the first through hole 121 and the outer edge of the frame sealant 3. The reliability verification confirms that the limit blank edge is 0.19 mm, ensuring that the first through hole 121 will not be exposed. The frame sealant 3 is used to cover the first through hole 121 located at the corner of the second substrate 12.

As shown in FIG. 11, after the frame sealant 3 shrinks, the second through hole 122 above the non-display area BB on the height side is exposed to the air, which poses a risk of corrosion. Therefore, a light shielding portion 23 is provided to cover the second through hole 122 to avoid corrosion. For example, the light shielding portion 23 not only serves as a black matrix shading function, but also covers the second through hole 122.

In the second aspect, an embodiment of the present disclosure provides a display device, including the display module 01 of any one of the first aspect.

The display device may be any product or component with a display function, such as a handset, a tablet computer, a television, a display, a laptop computer, a digital photo frame, a navigator, etc. Other essential components of the display device are well understood by those skilled in the art, and are not described in detail herein, nor should they be used as limitations to the present application.

Although the preferred embodiments of the present disclosure have been described, those skilled in the art may make additional changes and modifications to these embodiments once they have learned the basic creative concept. Therefore, the appended claims are intended to be interpreted as including the preferred embodiments and all changes and modifications falling within the scope of the present disclosure.

Obviously, those skilled in the art can make various changes and modifications to the present disclosure without departing from the spirit and scope of the present disclosure. Thus, if these modifications and variations of the present disclosure fall within the scope of the claims of this application and their equivalents, the present disclosure is also intended to include these modifications and variations.

1. A display module, comprising:
a backlight module;
a liquid crystal display panel located on a light-emitting side of the backlight module, wherein the liquid crystal display panel is divided into a display area and a non-display area located around the display area, and the liquid crystal display panel comprises a first substrate, a second substrate, and a liquid crystal layer located between the first substrate and the second substrate;
a light adjustment structure located in the non-display area and configured to shield light from the backlight module that is irradiated toward an edge of the display area of the liquid crystal display panel.

2. The display module according to claim 1, further comprising a height side and a bottom side arranged opposite to each other;
wherein the light adjustment structure is close to the height side.

3. The display module according to claim 2, wherein the liquid crystal display panel further comprises a first polarizer and a second polarizer; the first polarizer is arranged on a side of the first substrate facing away from the second substrate, and the second polarizer is arranged on a side of the second substrate facing away from the first substrate, and an orthographic projection of the first polarizer on the liquid crystal layer covers the liquid crystal layer in a thickness direction of the liquid crystal display panel, and an orthographic projection of the second polarizer on the liquid crystal layer covers the liquid crystal layer in the thickness direction of the liquid crystal display panel;
wherein the liquid crystal display panel further comprises a frame sealant; the frame sealant is located between the first substrate and the second substrate, an orthographic projection of the frame sealant on the first substrate is in a ring shape, and the frame sealant surrounds the liquid crystal layer.

4. The display module according to claim 3, wherein the light adjustment structure comprises a first polarizing portion and a second polarizing portion;
wherein the first polarizing portion and the first polarizer are disposed in a same layer, and the second polarizing portion and the second polarizer are disposed in a same layer; an orthographic projection of the first polarizing portion on the liquid crystal layer does not overlap with the liquid crystal layer in the thickness direction of the liquid crystal display panel, and an orthographic projection of the second polarizing portion on the liquid crystal layer does not overlap with the liquid crystal layer in the thickness direction of the liquid crystal display panel.

5. The display module according to claim 4, wherein in the thickness direction of the liquid crystal display panel, an orthographic projection of the first polarizing portion on the second polarizing portion coincides with a surface of the second polarizing portion facing the first polarizing portion.

6. The display module according to claim 5, wherein the first polarizing portion and the first polarizer are an integrated structure; the second polarizing portion and the second polarizer are an integrated structure.

7. The display module according to claim 3, wherein the light adjustment structure comprises a light shielding portion;
wherein the light shielding portion is located between the first substrate and the second substrate, and an orthographic projection of the light shielding portion on the first substrate is located in the non-display area in the thickness direction of the liquid crystal display panel.

8. The display module according to claim 7, wherein the light shielding portion comprises black sealant; and a width of the light shielding portion ranges from 5.5 mm to 7.5 mm in a direction from the bottom side to the height side.

9. The display module according to claim 3, wherein the light adjustment structure comprises a light blocking portion, the light blocking portion is located on a side of the second substrate facing the second polarizer, and an orthographic projection of the light blocking portion on the second substrate is located in the non-display area.

10. The display module according to claim 9, wherein the light blocking portion comprises a light shielding tape; and a width of the light shielding tape ranges from 3 mm to 4 mm in a direction from the bottom side to the height side.

11. The display module according to claim 3, wherein the light adjustment structure comprises the frame sealant filled with dyes of at least two colors.

12. The display module according to claim 3, wherein the light adjustment structure comprises dummy pixels, and the dummy pixels are located in a dummy pixel region between the display area and the non-display area;
wherein the dummy pixels are configured to display a black screen and to shield light at the edge of the display area.

13. The display module according to claim 12, wherein a width of the dummy pixels ranges from 1.5 mm to 2.5 mm in a direction from the bottom side to the height side.

14. The display module according to claim 13, wherein the orthographic projection of the frame sealant on the first substrate is completely located within a range of an orthographic projection of the dummy pixels on the first substrate.

15. The display module according to claim 14, wherein a distance between a side of the dummy pixels close to the height side and the height side ranges from 0.1 mm to 3.5 mm.

16. The display module according to claim 2, wherein a distance between a side of the light adjustment structure close to the height side and the height side ranges from 0.1 mm to 3.2 mm.

17. The display module according to claim 3, wherein the liquid crystal display panel further comprises a spacer, and the spacer is arranged between the first substrate and the second substrate;
an orthographic projection of the spacer on the first substrate does not overlap with the orthographic projection of the frame sealant on the first substrate.

18. The display module according to claim 17, wherein a distance between a side of the spacer close to the height side and the height side ranges from 5.7 mm to 8.3 mm.

19. The display module according to claim 3, wherein the frame sealant is configured to cover a first through hole located at a corner of the second substrate;
wherein a diameter of a corner of the frame sealant ranges from 0.4 mm to 0.6 mm.

20. A display device, comprising the display module according to claim 1.
